(19) United States
(12) Patent Application Publication
(10) Pub. No.: US 2026/0092390 A1
(43) Pub. Date: Apr. 2, 2026

(54) PLATING APPARATUS CONTROL METHOD AND PLATING APPARATUS

(71) Applicant: EBARA CORPORATION, Tokyo (JP)

(72) Inventors: Ryuya KOIZUMI, Tokyo (JP); Makoto HAMANO, Tokyo (JP); Kosei TAKEUCHI, Tokyo (JP)

(21) Appl. No.: 19/323,212

(22) Filed: Sep. 9, 2025

(30) Foreign Application Priority Data
Sep. 27, 2024 (JP) 2024-168089

(51) Int. Cl. C25D 21/12

(52) U.S. Cl. CPC C25D 21/12

(57) ABSTRACT

In a plating apparatus comprising multiple plating modules, it is desired to form a high-quality plating film by performing a plating process by using an appropriate plating module.

A method for controlling a plating apparatus, which comprises multiple plating modules, is provided, and the method comprises a step for obtaining plating-film-thickness measurement data of multiple substrates, wherein the multiple substrates are those with respect to which plating processes applied thereto by the multiple plating modules have been completed; a step for determining a degree of quality of each plating module in the multiple plating modules, based on the plating-film-thickness measurement data; and a step for controlling a plating process in the plating apparatus, based on the degree of quality of each plating module.

### TECHNICAL FIELD

The present invention relates to a plating apparatus control method and a plating apparatus.

### BACKGROUND ART

In relation to a semiconductor manufacturing apparatus such as a plating apparatus or the like, various kinds of substrates are processed in stages from a pre-processing stage to a post-processing stage. The costs for manufacturing a substrate are accumulated and raised higher as processing proceeds to that in later stages such as a post-processing stage and so on. Further, although it depends on a product, there may be a case wherein it is necessary to process an originally high-priced substrate. In general, a higher-quality process is required for processing a higher-priced substrate; and the cost of damage becomes higher if a defective product is produced due to occurrence of trouble in an apparatus or the like.

### CITATION LIST

### Patent Literature

PTL 1: Japanese Patent Application Public Disclosure No. 2006-206968

### SUMMARY OF INVENTION

### Technical Problem

In a plating apparatus comprising multiple plating modules, it is desired to form a high-quality plating film by performing a plating process by using an appropriate plating module.

### Solution to Problem

According to an embodiment, a method for controlling a plating apparatus, which comprises multiple plating modules, is provided, and the method comprises a step for obtaining plating-film-thickness measurement data of multiple substrates, wherein the multiple substrates are those with respect to which plating processes applied thereto by the multiple plating modules have been completed; a step for determining a degree of quality of each plating module in the multiple plating modules, based on the plating-film-thickness measurement data; and a step for controlling a plating process in the plating apparatus, based on the degree of quality of each plating module.

### BRIEF DESCRIPTION OF DRAWINGS

FIG. 1 is a general configuration diagram of a plating apparatus according to an embodiment of the present invention.

FIG. 2 is a schematic cross-sectional side view of a plating module in a plating processing unit in an embodiment of the present invention.

FIG. 3 is a configuration diagram of an example system for implementing a method according to an embodiment of the present invention.

FIG. 4 is a flow chart which shows operation of a system for implementing a method according to an embodiment of the present invention.

FIG. 5 is a figure which shows a construction of an example learning model used for implementing a method according to the present embodiment.

FIG. 6 is a flow chart which shows operation of a system for implementing a method according to a different embodiment of the present invention.

FIG. 7 shows an example of a database which stores degrees of qualities relating to respective substrate types and respective plating modules.

FIG. 8 is a flow chart which shows operation of a system for implementing a method according to a further different embodiment of the present invention.

FIG. 9 is a figure which shows a construction of an example learning model used for implementing a method according to the present embodiment.

### DESCRIPTION OF EMBODIMENTS

In the following description, embodiments of the present invention will be explained with reference to the figures. In the figures which will be explained below, a reference symbol that is the same as that assigned to one component is assigned to the other component which is the same as or corresponds to the one component, and overlapping explanation of those components will be omitted.

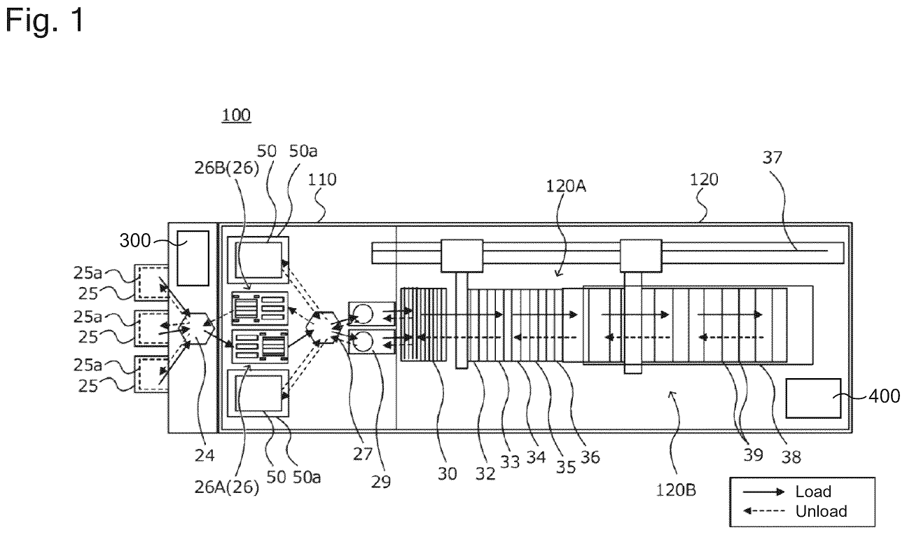

FIG. 1 is a general configuration diagram of a plating apparatus 100 according to an embodiment of the present invention. The plating apparatus 100 comprises a load/unload unit 110 for loading a substrate on a substrate holder (which is not shown in the figure) and unloading a substrate from a substrate holder, and a processing unit 120 for processing a substrate. The processing unit 120 further comprises a pre-processing/post-processing unit 120A for performing pre-processing and post-processing of a substrate, and a plating processing unit 120B for applying a plating process to a substrate.

The load/unload unit 110 comprises a handling stage 26, a substrate transfer device 27, a fixing station 29, and a washing unit 50a. For example, in the present embodiment, the load/unload unit 110 comprises two handling stages 26, specifically, a handling stage 26A for loading, which handles a substrate to which no process has been applied, and a handling stage 26B for unloading, which handles a substrate to which a process has been applied thereto. In the present embodiment, the construction of the handling stage 26A for loading is the same as that of the handling stage 26B for unloading, and they are arranged in such a manner that the directions thereof are 180-degree opposite from each other. In this regard, the handling stage 26 is not limited to that comprising the handling stage 26A for loading and the handling stage 26B for unloading, and the handling stages may be used without discrimination, i.e., without setting one of them to be a handling stage for loading and the other of them to be a handling stage for unloading. Further, in the present embodiment, the load/unload unit 110 comprises two fixing stations 29. The mechanisms of the two fixing stations 29 are identical with each other; and one, that is free (i.e., that is not handling a substrate), of them is used. In this regard, one or three or more handling stage/stages 26 and one or three or more fixing station/stations 29 may be installed according to the space in the plating apparatus 100.

Substrates are conveyed from multiple cassette tables 25 (for example, three in FIG. 1) to the handling stage 26 (the handling stage 26A for loading) via a robot 24. The cassette table 25 is provided with a cassette 25a in which a substrate is stored. For example, the cassette is a FOUP. The handling stage 26 is constructed in such manner that it adjusts (aligns) the position and the direction of a substrate put thereon. A substrate transfer device 27 is arranged in a position between the handling stage 26 and the fixing station 29, for conveying a substrate between them. The substrate transfer device 27 is constructed to convey a substrate between the handling stage 26, the fixing station 29, and the washing unit 50a. Further, a stocker 30, which is used for storing substrate holders, is installed in a position near the fixing station 29.

The washing unit 50a comprises a spin rinse dryer 50 for washing a substrate, after completion of a plating process applied thereto, and drying the substrate by rotating it at high speed. The substrate transfer device 27 is constructed to convey a substrate, with respect to which a plating process applied thereto has been completed, to the spin rinse dryer 50, and take the washed and dried substrate out of the spin rinse dryer 50. Thereafter, the washed and dried substrate is delivered to the handling stage 26 (the handling stage 26B for unloading) by the substrate transfer device 27, and returned to the cassette 25a via the robot 24.

The pre-processing/post-processing unit 120A comprises a pre-wet tank 32, a pre-soak tank 33, a pre-rinse tank 34, a blow tank 35, and a rinse tank 36. In the pre-wet tank 32, a substrate is soaked into pure water. In the pre-soak tank 33, an oxide film on a surface of a conductive layer, such as a seed layer or the like, formed on a surface of a substrate is removed by etching. In the pre-rinse tank 34, a substrate, with respect to which a pre-soaking process applied thereto has been completed, is washed together with a substrate holder by using cleaning liquid (pure water or the like). In the blow tank 35, liquid removal of a washed substrate is performed. In the rinse tank 36, a plated substrate is washed together with a substrate holder by using cleaning liquid. In this regard, the construction of the pre-processing/post-processing unit 120A is a mere example, and, accordingly, the construction of the pre-processing/post-processing unit 120A in the plating apparatus 100 is not limited to the above construction, and a different construction may be adopted in place thereof.

The plating processing unit 120B is constructed, for example, in such a manner that multiple plating tanks 39 are housed in the inside of an overflow tank 38. Each plating tank 39 is constructed in such a manner that it stores a single substrate therein, and soaks the substrate into plating liquid held in the inside thereof and applies plating such as copper plating or the like to a surface of the substrate.

The plating apparatus 100 comprises a transporter 37 which adopts, for example, a linear motor system, and is arranged in a position on a side of the pre-processing/post-processing unit 120A and the plating processing unit 120B, for conveying a substrate holder together with a substrate. The transporter 37 is constructed to convey a substrate holder between the fixing station 29, the stocker 30, the pre-wet tank 32, the pre-soak tank 33, the pre-rinse tank 34, the blow tank 35, the rinse tank 36, and the plating tank 39.

The plating apparatus 100 further comprises a film-thickness measuring unit 300 for measuring film thickness of a plating film formed on a substrate, and a controller 400 for performing various kinds of control operation for respective parts in the plating apparatus 100, analysis of various kinds of data relating to plating processes in the plating apparatus 100, and so on. In this regard, the film-thickness measuring unit 300 may be installed in such a manner that it is arranged, as a part of the plating apparatus 100, in a position in the inside of or beside the plating apparatus 100 as shown in FIG. 1; or it is arranged, as a device which is separate from and independent of the plating apparatus 100, in a position distant from that of the plating apparatus 100. Further, the controller 400 may also be installed in such a manner that it is arranged, as a part of the plating apparatus 100, in a position in the inside of or beside the plating apparatus 100 as shown in FIG. 1; or it is arranged, as a device which is separate from and independent of the plating apparatus 100, in a position distant from that of the plating apparatus 100, and communicably connected to the plating apparatus 100 and the film-thickness measuring unit 300 via a network such as a LAN (local area network), the Internet, or the like.

An example of a series of plating processes performed by the plating apparatus 100 will be explained. First, by the robot 24, a single substrate is taken out of the cassette 25a loaded in the cassette table 25; and the substrate is conveyed to the handling stage 26 (the handling stage 26A for loading). The handling stage 26 aligns the position and the direction of the conveyed substrate with a predetermined position and a predetermined direction. The substrate, with respect to which the position and the direction have been aligned in the handling stage 26, is conveyed to the fixing station 29 by the substrate transfer device 27.

On the other hand, a substrate holder stored in the stocker 30 is conveyed to the fixing station 29 by the transporter 37, and put horizontally on the fixing station 29. Thereafter, the substrate conveyed by the substrate transfer device 27 is put on the substrate holder which is in the above state, and the substrate and the substrate holder are coupled with each other.

Next, the substrate holder, which holds the substrate, is grasped by the transporter 37, and stored in the pre-wet tank 32. Next, the substrate holder, which holds the substrate with respect to which the process applied thereto in the pre-wet tank 32 has been completed, is conveyed to the pre-soak tank 33 by the transporter 37, and an oxide film on the substrate is etched in the pre-soak tank 33. Following thereto, the substrate holder, which holds the above substrate, is conveyed to the pre-rinse tank 34 to water-wash the surface of the substrate by pure water stored in the pre-rinse tank 34.

The substrate holder, which holds the substrate with respect to which the water-washing process applied thereto has been completed, is conveyed from the pre-rinse tank 34 to the plating processing unit 120B by the transporter 37 to store it in the plating tank 39 which is filled with plating liquid. The transporter 37 repeats the above procedures sequentially to store respective substrate holders, which hold respective substrates, in respective plating tanks 39 in the processing unit 120 sequentially.

In each of the plating tanks 39, a surface of the substrate is plated by applying a plating voltage between an anode (which is not shown in the figure) in the plating tank 39 and the substrate.

After completion of plating, the substrate holder, which holds the plated substrate, is grasped by the transporter 37 and conveyed to the rinse tank 36 to soak it into pure water stored in the rinse tank 36 to wash the surface of the substrate by the pure water. Next, the substrate holder is conveyed to the blow tank 35 by the transporter 37 to remove water droplets remaining on the substrate holder by air-blowing or the like. Thereafter, the substrate holder is conveyed to the fixing station 29 by the transporter 37.

In the fixing station 29, the processed substrate is taken out of the substrate holder by the substrate transfer device 27, and conveyed to the spin rinse dryer 50 in the washing unit 50a. The spin rinse dryer 50 washes the substrate, with respect to which the plating process applied thereto has been completed, and dries the substrate by rotating it at high speed. The dried substrate is delivered to the handling stage 26 (the handling stage 26B for unloading) by the substrate transfer device 27, and returned to the cassette 25a via the robot 24.

Thereafter, the film thickness of the plating film formed on the substrate is measured by the film-thickness measuring unit 300. Film-thickness measurement data of the plating film is supplied to the controller 400 for the purpose of analysis.

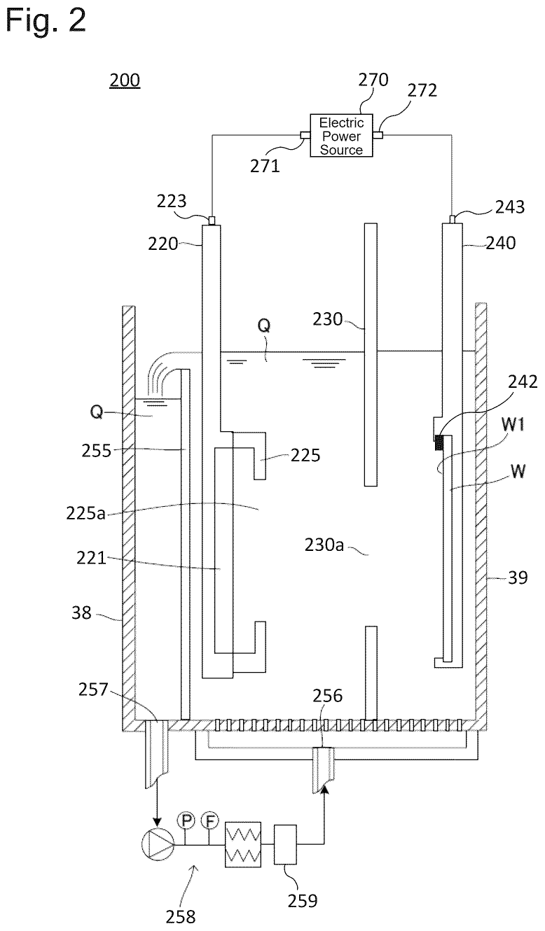

FIG. 2 is a schematic cross-sectional side view of a plating module 200 in the above-explained plating processing unit 120B. As shown in the figure, the plating module 200 comprises an anode holder 220 which is constructed to hold an anode 221, a substrate holder 240 which is constructed to hold a substrate W, the plating tank 39 which stores plating liquid Q including an additive, and an overflow tank 38 which receives and discharges a quantity of plating liquid Q overflowed from the plating tank 39. The plating tank 39 and the overflow tank 38 are separated from each other by a partition wall 255. The anode holder 220 and the substrate holder 240 are housed in the inside of the plating tank 39. As explained above, the substrate holder 240 holding the substrate W is conveyed by the transporter 37 (refer to FIG. 1) and housed in the plating tank 39.

In this regard, although FIG. 2 is that showing a single plating module 200 only, the plating processing unit 120B in the plating apparatus 100 may comprise, as explained above, multiple plating modules 200, each comprising a construction identical with the construction shown in FIG. 2.

The anode 221 is electrically connected to a positive terminal 271 of an electric power source 270 via an electric terminal 223 installed on the anode holder 220. The substrate W is electrically connected to a negative terminal 272 of the electric power source 270, via a power-supplying contact 242 and an electric terminal 243 installed on the substrate holder 240. The power-supplying contact 242 of the substrate holder 240 is in contact with a periphery of the substrate W. The electric power source 270 is constructed in such a manner that it supplies plating electric current between the anode 221 connected to the positive terminal 271 and the substrate W connected to the negative terminal 272, and also measures a voltage applied between the positive terminal 271 and the negative terminal 272.

The anode holder 220 holding the anode 221 and the substrate holder 240 holding the substrate W are soaked in the plating liquid Q in the plating tank 39, and arranged to face with each other in such a manner that the anode 221 and the to-be-plated surface W1 of the substrate W are positioned in virtually parallel with each other. In the state that the anode 221 and the substrate W are being soaked in the plating liquid Q in the plating tank 39, the plating electric current is supplied from the electric power source 270. As a result, metal ions in the plating liquid Q are deoxidized on the to-be-plated surface W1 of the substrate W, and a film is formed on the to-be-plated surface W1.

The anode holder 220 comprises an anode mask 225 for adjusting an electric field between the anode 221 and the substrate W. The anode mask 225 is a member which is virtually tabular and comprises dielectric material, for example, and installed on a front surface side of the anode holder 220 (a surface on a side facing the substrate holder 240). That is, the anode mask 225 is positioned between the anode 221 and the substrate holder 240. The anode mask 225 comprises a first opening 225a which is positioned approximately in the center thereof, and through which the electric current flowing between the anode 221 and the substrate W passes. It is preferable that the diameter of the opening 225a be smaller than the diameter of the anode 221. The anode mask 225 may be constructed in such a manner that the diameter of the opening 225a is adjustable.

The plating module 200 further comprises a regulation plate 230 for adjusting the electric field between the anode 221 and the substrate W. The regulation plate 230 is a member which is virtually tabular and comprises dielectric material, for example, and arranged in a position between the anode mask 225 and the substrate holder 240 (the substrate W). The regulation plate 230 comprises a second opening 230a, through which the electric current flowing between the anode 221 and the substrate W passes. It is preferable that the diameter of the opening 230a be smaller than the diameter of the substrate W. The regulation plate 230 may be constructed in such a manner that the diameter of the opening 230a is adjustable.

A paddle, which is not shown in the figure, is arranged in a position between the regulation plate 230 and the substrate holder 240, for stirring the plating liquid Q existing in a region near the to-be-plated surface W1 of the substrate W. The paddle is a member having a virtually rod shape, and is horizontally moved in a direction along the to-be-plated surface W1 of the substrate W; so that the plating liquid Q is stirred.

The plating tank 39 comprises a plating liquid supply port 256 for supplying the plating liquid Q to the inside of the tank. The overflow tank 38 comprises a plating liquid exhaust port 257 for discharging a quantity of plating liquid Q overflowed from the plating tank 39. The plating liquid supply port 256 is arranged in a position on the bottom of the plating tank 39, and the plating liquid exhaust port 257 is arranged in a position on the bottom of the overflow tank 38.

When the plating liquid Q is being supplied from the plating liquid supply port 256 to the plating tank 39, a quantity of plating liquid Q overflows from the plating tank 39, and flows into the overflow tank 38 over the partition wall 255. The plating liquid Q flown into the overflow tank 38 is discharged from the plating liquid exhaust port 257, and impurities therein are removed by a filter or the like included in a plating liquid circulating device 258. The plating liquid Q, from which the impurities have been removed, is supplied to the plating tank 39 by the plating liquid circulating device 258 via the plating liquid supply port 256. The plating liquid circulating device 258 may be provided with a plating liquid analyzing device 259 for measuring a temperature of the plating liquid Q, a flow rate (the quantity of the plating liquid Q supplied per unit time from the plating liquid supply port 256 to the plating tank 39), a concentration of each of kinds of liquid chemical components included in the plating liquid Q, and so on.

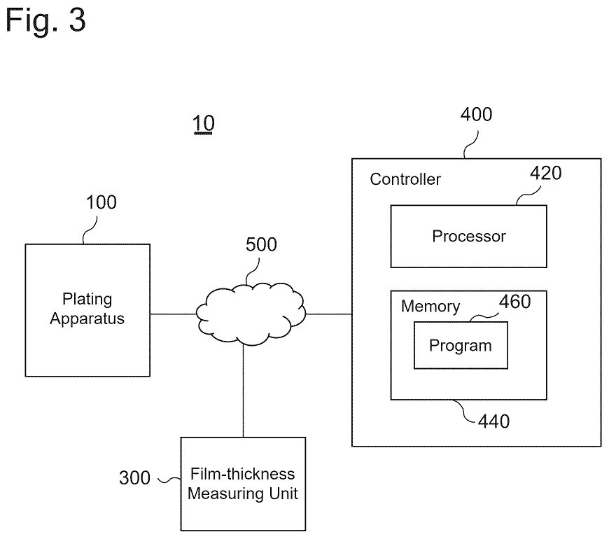

FIG. 3 is a configuration diagram of an example system 10 for implementing a method according to an embodiment of the present invention. The system 10 comprises a plating apparatus 100, a film-thickness measuring unit 300, and a controller 400. The plating apparatus 100 is the plating apparatus explained with reference to FIG. 1. The plating apparatus 100, the film-thickness measuring unit 300, and the controller 400 are mutually connected, for example, by a network 500 such as a LAN (local area network), the Internet, or the like for allowing communication between them. In a different construction, the film-thickness measuring unit 300 and the controller 400 may be incorporated in the plating apparatus 100 as components of the construction of the plating apparatus 100, as shown in above-explained FIG. 1. The controller 400 comprises a processor 420 and a memory 440. The memory 440 stores a program 460 (computer-executable instructions) for realizing the method according to the embodiment of the present invention. The processor 420 reads the program 460 out of the memory 440 and executes it. As a result, the method according to the embodiment of the present invention is realized.

### First Embodiment

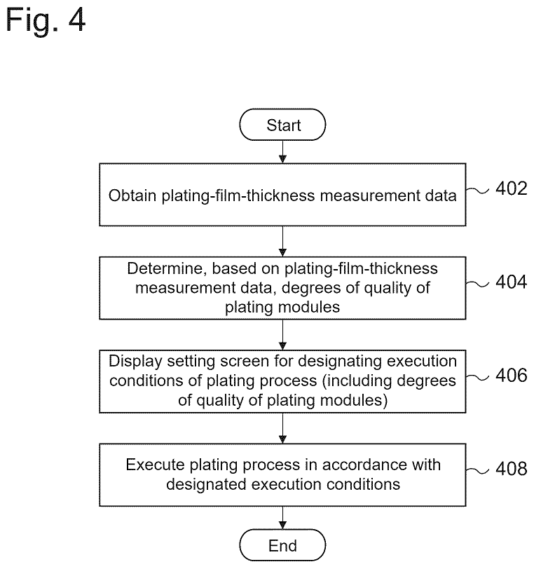

FIG. 4 is a flow chart which shows operation of the system 10 for implementing the method according to the embodiment of the present invention. Processing in each of the steps in the flowchart in FIG. 4 is performed by the processor 420 in the controller 400 in the system 10. The method according to the embodiment in FIG. 4 starts from step 402, during the time when the plating apparatus 100 is in operation.

First, in step 402, the processor 420 obtains plating-film-thickness measurement data for multiple substrates with respect to which the plating processes applied by the multiple plating modules 200 in the plating apparatus 100 have been completed. For example, many substrates are processed in the plating apparatus 100. With respect to each substrate, a plating process is applied thereto by one of the multiple plating modules 200 according to a predetermined recipe. For example, each of substrates in a group is subjected to a plating process performed by a first plating module in the multiple plating modules 200, and each of substrates in a different group is subjected to a plating process performed by a second plating module in the multiple plating modules 200. Matters similar to those in the above example also apply to a third plating module, a fourth plating module, and so on in the multiple plating modules 200. Each substrate, with respect to which a plating process applied thereto by one of the plating modules 200 in the plating apparatus 100 has been completed, is conveyed to the film-thickness measuring unit 300, and film-thickness measurement of a plating film formed by the plating process is performed in the film-thickness measuring unit 300. The film-thickness measurement may be that comprising a process for measuring film thickness of a plating film, for example, at many measurement points on a to-be-plated surface W1, preferably, at many measurement points distributed on the entire to-be-plated surface W1 of each substrate. The data of result of film-thickness measurement, which was performed by the film-thickness measuring unit 300, of each substrate (in this specification, this data is also referred to as plating-film-thickness measurement data, or is simply referred to as film-thickness measurement data) is sent to the controller 400 and obtained by the processor 420. Regarding each of the plating modules 200 in the plating apparatus 100, plating-film-thickness measurement data relating to one or multiple substrates, which was/were processed in the plating module 200, is obtained. The plating-film-thickness measurement data may be stored temporarily or permanently in the memory 440 in the controller 400.

Next, in step 404, the processor 420 determines, based on the plating-film-thickness measurement data obtained in step 402, the degree of quality of each of the multiple plating modules 200 in the plating apparatus 100. The degree of quality of a plating module 200 is an index that represents capability of the plating module 200 relating to the degree of quality of a plating film achievable by the plating module 200. For example, the quality of a plating film may be determined based on matters including, but not limited to, a difference between a target film thickness value of a plating film and a film thickness value of an actually formed plating film (i.e., whether it is possible to form a plating film having a target film thickness value), uniformity in a plating film on a substrate plane (i.e., whether it is possible to form a flat plating film), and so on. As explained above, in step 402, the plating-film-thickness measurement data was obtained with respect to each of the multiple plating modules 200 in the plating apparatus 100; and, in step 404, the processor 420 determines the degree of quality of each of the plating modules 200 by using the plating-film-thickness measurement data relating to each of the multiple plating modules 200.

For example, the process for determining the degree of quality of the plating module 200 may be that based on statistical analysis of the plating-film-thickness measurement data. The processor 420 may calculate, from the plating-film-thickness measurement data, one or multiple statistical values of various kinds; and determine, based on the calculated statistical value(s), the degree of quality of each of the plating modules 200. For example, the statistical values may be those including, but not limited to, an average value of the degrees of in-plane uniformity of plating-film thickness with respect to multiple substrates, an average value of errors, that are deviated from a target film thickness value of plating film thickness, with respect to multiple substrates, and so on. For example, for each of the plating modules 200, the processor 420 may calculate, with respect to each of substrates processed in the plating module 200 and from the plating-film-thickness measurement data of the substrate, the degree of in-plane uniformity of the plating film thickness of the substrate; and calculate an average value of the degrees of in-plane uniformity of the plating film thicknesses of the substrates. For each of the plating modules 200, the processor 420 determines the degree of quality of the plating module, based on the average value of the degrees of in-plane uniformity of the plating film thicknesses calculated as explained above, and/or based on a similarly calculated average value of errors deviated from a target film thickness value of a plating film thickness. Instead of using the average values such as those explained above, a statistical value such as a maximum value, a minimum value, or variance may be used. For example, the degree of quality may be given as a numerical value in a range from 0 to 100, or a symbol such as A, B, C, or the like. An appropriate method may be used as a tangible method for converting the calculated statistical value (for example, the average value) to the degree of quality, or assigning the degree of quality to the calculated statistical value; and detailed explanation with respect to such a method will not be explained herein.

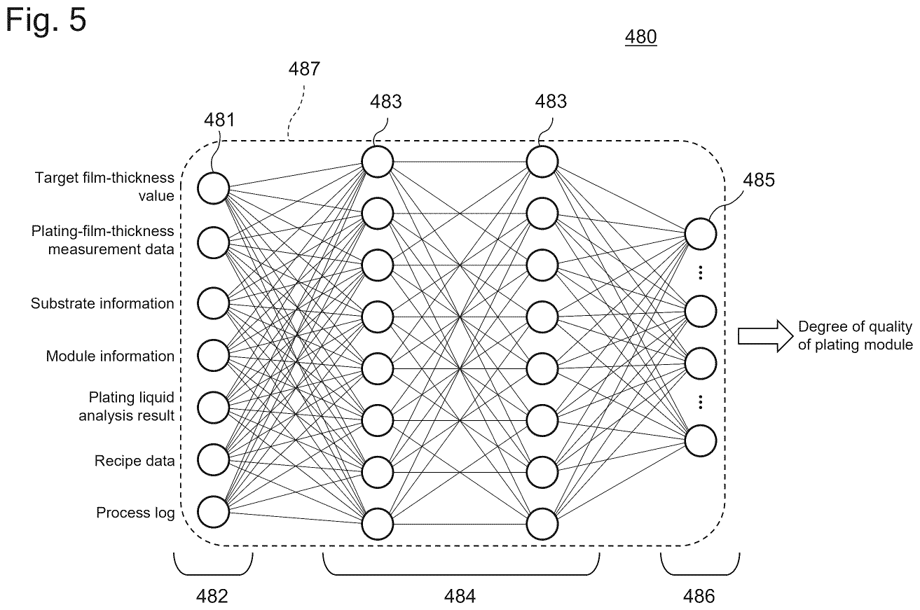

In a different mode, the process for determining the degree of quality of a plating module 200 may be performed by using a learning model which has been trained by performing machine learning. FIG. 5 is a figure which shows a construction of an example learning model 480 used for implementing a method according to the present embodiment. For example, a learning model 480 may be constructed in the controller 400, by reading the program 460 stored in the memory 440 in the controller 400 and executing the program by the processor 420. The learning model 480 is constructed to determine the degree of quality of each of the plating modules 200 in the plating apparatus 100. The learning model 480 is trained by using multiple pieces of training data, for constructing it to be able to correctly determine the degree of quality of the plating module 200.

As shown in FIG. 5, the example learning model 480 is constructed by using a neural network 487 which comprises an input layer 482 having multiple input nodes 481, a middle layer 484 which comprises one or multiple layers, each having multiple nodes 483, and an output layer 486 having one or multiple output nodes 485. Each node is connected, with strength levels characterized by weight parameters, to multiple nodes in a layer adjacent to a layer to which the above node belongs. One or multiple kinds of pieces of data, that correlate to the degree of quality of the plating module 200, are inputted to the multiple input nodes 481 in the input layer 482. An estimated value with respect to the degree of quality of the plating module 200 is outputted, according to the pieces of data inputted to the input nodes 481, from the output node 485 in the output layer 486. The weight parameters, that are set between the respective nodes in the neural network 487, are adjusted to make the above estimated value coincide with a predetermined ground truth label. The process for adjusting parameters in the neural network 487 is repeatedly performed by using multiple sets of pieces of training data. In this manner, training of the learning model 480 is performed.

At least a target value relating to the plating film thickness and plating-film-thickness measurement data relating to a substrate which has actually been processed in a plating module 200 are inputted, as pieces of data that correlate to the degree of quality of the plating module 200, to the input nodes 481 of the learning model 480. The target values relating to the plating film thickness (hereinafter, the film-thickness target value) may comprise, for example, a target value of plating film thickness at a predetermined reference point on a substrate, a target value of average plating film thickness in a substrate surface, a target value of uniformity of plating film thickness over a substrate surface, or the like. For example, after film-thickness target values such as those shown above are set by an administrator of the plating apparatus 100, a plating process for a substrate is actually performed in one of the plating modules 200 in the plating apparatus 100, and plating-film-thickness measurement data relating to the substrate is obtained by the film-thickness measuring unit 300. Further, the plating-film-thickness measurement data is evaluated by the administrator of the plating apparatus 100, to prepare, by the administrator, a ground truth label for the degree of quality with respect to the plating module 200 which has processed the substrate. The film-thickness target value, the plating-film-thickness measurement data, and the ground truth label, that have been explained above, are grouped as a set of training data, and the learning model 480 are trained by using the set of training data. Specifically, the film-thickness target value and the plating-film-thickness measurement data are inputted to the input nodes 481; and, based on an estimated value of the degree of quality, that is outputted from the output node 485 in response to the above input, and the ground truth label, the weight parameters between nodes in the neural network 487 are adjusted. By performing parameter adjustment similar to that explained above by using a large number of sets of training data, a learning model 480 which is able to accurately determine the degree of quality of a plating module 200 is finally constructed.

In the present mode, in step 404, the plating-film-thickness measurement data obtained in above-explained step 402 and the film-thickness target value relating thereto are inputted to the input nodes 481 of the leaning model 480 such as that trained as explained above. In response the above input, an estimated value of the degree of quality of the plating module is outputted from the output node 485 of the trained learning model 480. In the above manner, determining of the degree of quality of each of the multiple plating modules 200 in the plating apparatus 100 is performed by the trained learning model 480.

In addition to the film-thickness target value and the plating-film-thickness measurement data explained above, additional data correlating to the degree of quality of the plating module 200 may be inputted to the input nodes 481 of the leaning model 480. Such additional data may comprise, for example, at least one of substrate information relating to a characteristic(s) of a substrate, module information relating to the plating process in the plating module 200, and analysis result relating to components of the plating liquid Q used in the plating module 200.

The substrate information in the additional data may comprise, for example, the size, shape, and material of a substrate, the thickness and material of a seed layer formed on a surface of the substrate, the thickness of a resist film formed on the substrate, the size, shape, position, opening area, and opening ratio of an opening formed on a resist film, and so on. The substrate information may be identifiers (for example, substrate-type A, substrate-type B, and so on) that are used to classify the types of substrates according to the above respective items. The quality or characteristic of a plating film formed on a substrate by the plating module 200 are influenced by these various kinds of characteristics of the substrate. Accordingly, by using such substrate information as an input to the learning model 480, accuracy of determination of the degree of quality of the plating module 200, that is to be outputted from the learning model 480, can be improved. Especially, the degree of quality of the plating module 200 can be determined more accurately according to the type of a substrate.

Further, the module information in the additional data may comprise, for example, dimension and position information of various kinds of components in the plating tank 39 in the plating module 200 (for example, distances between respective components such as the anode 221, the anode mask 225, the regulation plate 230, and the substrate W, and errors deviated from their designed values), the temperature of the plating liquid Q in the plating tank 39, the temperature distribution in the plating liquid Q (differences between respective temperatures at respective regions in the plating tank 39), the temporal stability of temperature of the plating liquid Q, the flow rate and temporal stability thereof of the plating liquid Q, and so on. The temperature and the flow rate of the plating liquid Q can be obtained from the plating liquid analyzing device 259. The quality or characteristic of a plating film formed on a substrate by a plating module 200 is influenced by an individual difference between the plating modules 200 such as those explained above. Accordingly, by using, as input to the learning model 480, module information such as that explained above, accuracy of determination of the degree of quality of the plating module 200, that is to be outputted from the learning model 480, can be improved. Especially, the degree of quality of the plating module 200 can be determined more accurately, with respect to each of the multiple plating modules 200 included in the plating apparatus 100.

The analysis result relating to the components of the plating liquid Q, that is in the additional data, is obtained from the plating liquid analyzing device 259. The plating liquid Q comprises, for example, an accelerator and/or an inhibitor as additives. The accelerator is a component for accelerating extraction in plating, and the inhibitor is a component for suppressing extraction in plating. Local or global uniformity of a plating film formed on a substrate is influenced by the concentration of an accelerator and an inhibitor such as those explained above. Accordingly, by using, as input to the learning model 480, analysis result relating to components of a plating liquid Q such as that explained above, accuracy of determination of the degree of quality of the plating module 200, that is to be outputted from the learning model 480, can be improved.

Further, recipe data and a process log may be used as additional date to be inputted to the input nodes 481 of the learning model 480. The recipe data comprises, for example, a setting value of plating current supplied to a substrate, a setting value of time of electric conduction to the substrate, setting values of the sizes of the openings in the anode mask 225 and the regulation plate 230, and so on. The process log comprises, for example, log data of plating current that has actually been supplied to a substrate during processing, a log of actual time of electric conduction to the substrate during processing, and so on. By using the above pieces of data as input to the learning model 480, accuracy of determination of the degree of quality of the plating module 200 can be improved further.

FIG. 4 is referred to again; and, next, in step 406, the processor 420 displays, in a user interface (for example, a display) of the controller 400, a setting screen for designating conditions with respect to execution of the plating process. The plating process execution conditions comprise designation of the degree of quality of a plating module which is to be used in the plating process. For example, there may be a case that an “important substrate” which requires more careful handling than other substrates may be included in a large number of substrates which are to be processed in the plating apparatus 100. With respect to the important substrate, it is required to perform a plating process in such a manner that a high-quality plating film (for example, a plating film having high in-plane uniformity of film thickness) is to be formed in a plating module 200. In the case that a plating process is to be performed for such an important substrate, an administrator/operator of the plating apparatus 100 designates, via the user interface (an input means), the matter such that a plating process to be applied to the important substrate should be performed by a plating module which has a high degree of quality (i.e., a plating module with respect to which forming of a high-quality plating film can be expected) in the multiple plating modules 200. For example, in the case that the degrees of quality of the plating modules 200 are classified into three grades, specifically, “A” that means that the degree of quality is high, “B” that means that the degree of quality is medium, and “C” that means that the degree of quality is relatively low, the administrator/operator of the plating apparatus 100 designates the degree of quality “A,” in terms of a plating module 200 which is to be used for performing the plating process for the important substrate. In this regard, in the case that a plating process is to be applied to a regular substrate which is not an important substrate, the degree of quality “B” or “C” may be designated.

Next, in step 408, the processor 420 controls the plating apparatus 100 to make it perform the plating process in accordance with the execution conditions designated in step 406. Specifically, the processor 420 selects, from the multiple plating modules 200 in the plating apparatus 100, a plating module which matches the degree of quality designated in step 406, and controls the plating apparatus 100 to perform the plating process by using the selected plating module 200. For example, in the case that the degree of quality “A” is designated in step 406, a plating module 200 having the degree of quality “A” is selected, and the plating process is applied to the substrate in the plating module 200.

As explained above, according to the present embodiment, a plating process for a substrate can be performed by using a plating module 200 having an appropriate degree of quality, by determining the degree of quality of each of the multiple plating modules 200 in the plating apparatus 100, and designating a degree of quality of a plating module which should be used for performing the plating process for the substrate. By adopting the above construction, a plating film having quality that is appropriate for each substrate can be formed, occurrence of failure in processing can be reduced, and, accordingly, efficient operation of the plating apparatus 100 can be realized.

It should be reminded that, in terms of above-explained steps 406 and 408, the plating process execution conditions may include additional execution conditions other than the degree of quality of the plating module 200. For example, the setting screen displayed in the controller 400 in step 406 may comprise, as additional execution conditions for the plating process, one or more of designation that designates the degree of priority with respect to timing to start processing of a substrate which is an object of processing, designation that designates the speed for conveying a substrate, designation that designates the degree of priority of salvaging of a substrate at the time when an error has occurred, and designation that designates an operation condition at the time when the process restarts after occurrence of an error. For example, with respect to the designation that designates the degree of priority with respect to timing to start processing of a substrate, it may allow selection of any one of “Prior” that designates a condition that a substrate is to be processed before processing of other substrates, “Later” that designates a condition that a substrate is to be processed after processing of other substrates, and “No designation” that designates a condition that a substrate is to be processed according to a usual order of processing of substrates. Further, with respect to the designation that designates the speed for conveying a substrate, it may allow selection of one of “Usual” and “Low speed,” for example. Further, with respect to the designation that designates the degree of priority of salvaging of a substrate at the time when an error has occurred, it may allow selection of any one of “Prior” that designates a condition that a substrate is to be collected and put into a cassette 25a loaded on the cassette table 25 in the plating apparatus 100 before other substrates are collected, “Later” that designates a condition that a substrate is to be collected after other substrates are collected, and “No designation” that designates a condition other than the above conditions. Further, with respect to the designation that designates operation conditions at the time of restarting of the process, it may allow selection of a processing step that is to be performed at the time when restarting the process (for example, selecting whether the process is to be restarted from a washing process or a plating process), for example. In step 408, the plating process may be executed in accordance with the above designated conditions.

### Second Embodiment

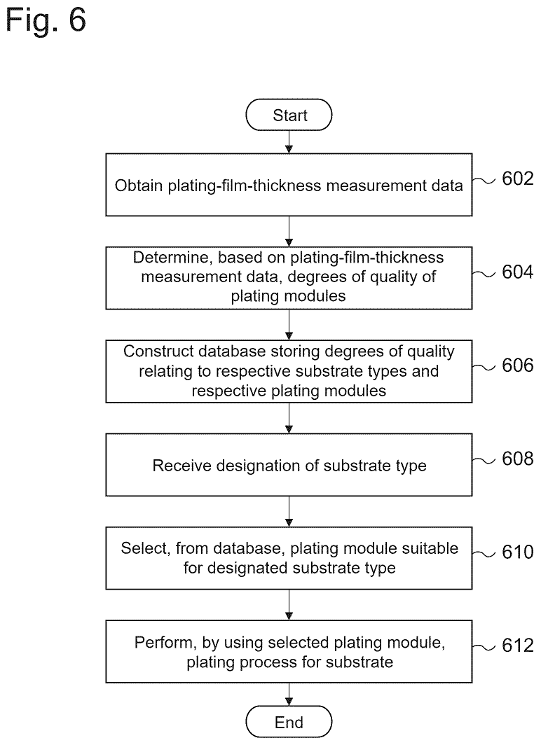

FIG. 6 is a flow chart which shows operation of the system 10 for implementing a method according to a different embodiment of the present invention. Processing in each of the steps in the flowchart in FIG. 6 is performed by the processor 420 in the controller 400 in the system 10. The method according to the embodiment in FIG. 6 starts from step 602, during the time when the plating apparatus 100 is in operation.

In step 602, the processor 420 obtains plating-film-thickness measurement data for multiple substrates with respect to which the plating processes applied thereto by the multiple plating modules 200 in the plating apparatus 100 have been completed. In step 604 that follows the above step, the processor 420 determines, based on the plating-film-thickness measurement data obtained in step 602, the degree of quality of each of the multiple plating modules 200 in the plating apparatus 100. The processes in steps 602 and 604 are the same as those in steps 402 and 404 in the above-explained flowchart (the first embodiment) in FIG. 4.

Next, in step 606, based on the degrees of quality obtained in step 604, the processor 420 constructs a database which stores the degrees of quality relating to respective substrate types and respective plating modules. As understood from the above explanation of steps 402 and 404 relating to the first embodiment, in step 604, regarding each of the plating modules 200 in the plating apparatus 100, result of determination of the degree of quality of the plating module 200 is obtained in relation to each of multiple types of substrates processed by the plating module 200. In step 606, the database is constructed by using the result of determination of the respective degrees of quality of the plating module 200 corresponding to the respective types of substrates processed by the plating module 200.

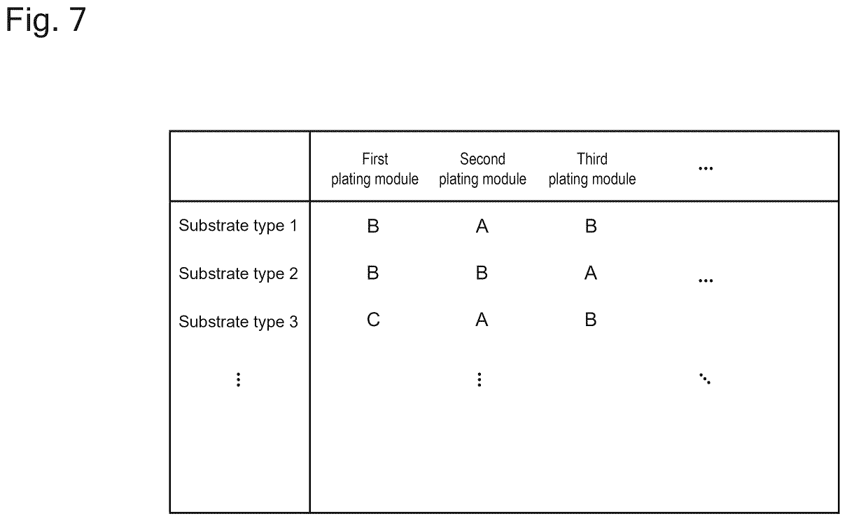

FIG. 7 shows an example of the database constructed in step 606. In the example, each of the degrees of quality of a plating module is represented by one of “A,” “B,” and “C.” According to the above example database, for example, with respect to a substrate of “Substrate-type 1,” the degree of quality of a first plating module in the multiple plating modules 200 is “B,” the degree of quality of a second plating module is “A,” the degree of quality of a third plating module is “B,” and so on. Accordingly, it can be understood that, in the case that a plating process is to be applied to a substrate of “Substrate-type 1,” a plating film having the highest quality (for example, the best in-plane uniformity) can be formed by performing the plating process by using the second plating module.

Next, in step 608, the processor 420 receives designation that designates a substrate type. For example, the administrator/operator of the plating apparatus 100 inputs, via the interface screen in the controller 400, recipe information that indicates various kinds of process conditions that are required when applying a plating process to a substrate in the plating apparatus 100. As a part of the recipe information, designation that designates a substrate type (for example, “Substrate-type 1”) of a substrate, to which a plating process will be applied soon, may be inputted.

Next, in step 610, the processor 420 selects, from the database and based on the substrate type designated in step 608, a plating module suitable for the substrate type. Here, the example database in the above-explained FIG. 7 is referred to; and, for example, if the “Substrate-type 1” is designated in step 608, the processor 420 selects, as a plating module which is to be used for applying a plating process to a substrate of the “Substrate-type 1,” the second plating module which is a plating module 200 having the degree of quality “A” with respect to a “Substrate-type 1” substrate. Also, for example, if the “Substrate-type 2” is designated in step 608, and if it has been determined with respect to a “Substrate-type 2” substrate, by taking processing in the plating apparatus 100 taken into consideration in advance, that especially careful handling is not required and usual careful handling is sufficient for the substrate, the processor 420 may select, as a plating module which is to be used for applying a plating process to the “Substrate-type 2” substrate, a plating module having the degree of quality “B” rather than “A” (for example, the first plating module). The processor 420 may be constructed in such a manner that it always selects a plating module having the degree of quality “A” for a substrate of any substrate type.

Next, in step 612, the processor 420 controls the plating apparatus 100 to perform, by using the plating module selected in step 610, a plating process applied to the substrate of the substrate type designated in step 608. As a result, a plating process for a substrate is performed by using a plating module 200 suitable for a substrate type.

As explained above, according to the present embodiment, by using a database which stores, in relation to respective substrate types, the degrees of quality of respective plating modules 200 in the plating apparatus 100, it becomes possible to perform a plating process for each of substrates by using a plating module 200 having a degree of quality which matches a substrate type of the substrate. Accordingly, further efficient operation of the plating apparatus 100 can be realized, since a plating film having appropriate quality can always be formed on a substrate of any substrate type, and a plating module which does not have the highest degree of quality may be allowed to be used, in some cases, for substrates of some substrate types.

### Third Embodiment

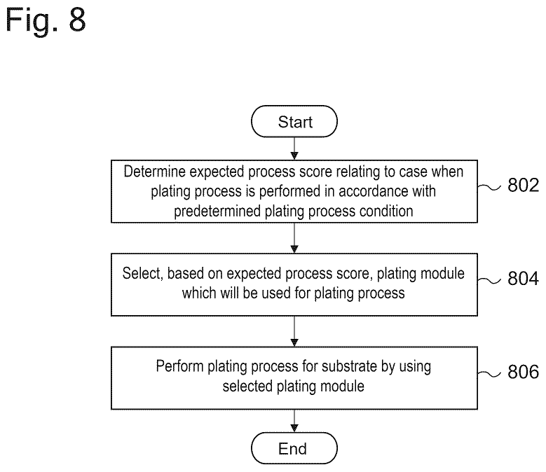

FIG. 8 is a flow chart which shows operation of the system 10 for implementing a method according to a further different embodiment of the present invention. Processing in each of the steps in the flowchart in FIG. 8 is performed by the processor 420 in the controller 400 in the system 10. The method according to the embodiment in FIG. 8 starts from step 802, before starting of the process in the plating apparatus 100.

First, in step 802, the processor 420 determines, based on a predetermined plating process condition, an expected score relating to the quality of thickness of a plating film which may be formed when a plating process is performed in accordance with the plating process condition. Determining of the expected score (hereinafter, an expected process score) is performed by using a learning model which is trained by machine learning to make it output an expected process score when a predetermined plating process condition(s) is(are) inputted.

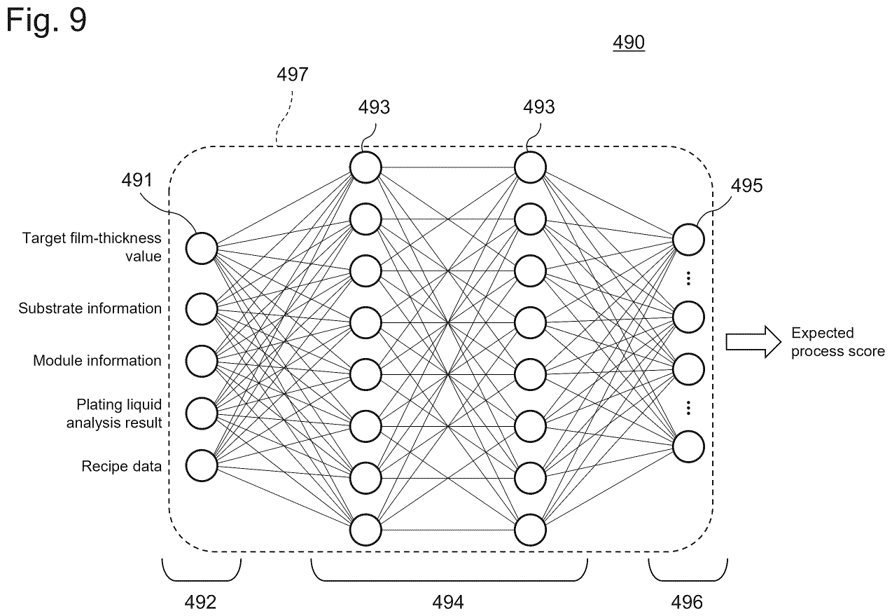

FIG. 9 is a figure which shows a construction of an example learning model 490 used for implementing the method according to the present embodiment. For example, the learning model 490 may be constructed in the controller 400, by reading the program 460 stored in the memory 440 in the controller 400 and executing the program by the processor 420. The learning model 490 is constructed to determine an expected process score relating to the quality of thickness of a plating film formed under a predetermined plating process condition. The learning model 490 is trained by using multiple pieces of training data, for constructing it to be able to correctly determine the expected process score.

As shown in FIG. 9, the learning model 490 is constructed by using a neural network 497 which comprises an input layer 492 having multiple input nodes 491, a middle layer 494 which comprises one or multiple layers, each having multiple nodes 493, and an output layer 496 having one or multiple output nodes 495. Each node is connected, with strength levels characterized by weight parameters, to multiple nodes in a layer adjacent to a layer to which the above node belongs.

Predetermined plating process conditions, that are to be applied when a plating process is applied to a substrate by a plating module 200 in the plating apparatus 100, are inputted to the input nodes 491 in the learning model 490. The predetermined plating process conditions comprise a film-thickness target value, substrate information, module information, concentration of each of components in the plating liquid, and recipe data. One or more of the above conditions may be excluded. Since the film-thickness target value, substrate information, module information, concentration of each of components in the plating liquid, and recipe data in the above explanation have already been explained in relation to the learning model 480 in the first embodiment, overlapping explanation relating them will be omitted in this section. A score (an expected process score), that relates to the quality of the thickness of a plating film which is expected to be formed on a substrate in the case that a plating process is performed in accordance with the plating process conditions inputted to the input nodes 491, is outputted from an output node 495 in the learning model 490. The weight parameters, that are set between the respective nodes in the neural network 497, are adjusted to make the above expected process score coincide with a predetermined ground truth label, to thereby train the learning model 490. The ground truth label is prepared in advance by actually performing the plating process for the substrate under the above plating process conditions. That is, a ground truth label is created by using data relating to plating processes that were actually performed previously. For example, an administrator of the plating apparatus 100 may create a ground truth label, that represents the quality of the thickness of a plating film, by evaluating plating-film-thickness measurement data that was obtained when plating processes were actually performed for substrates under the above plating process conditions. The learning model 490 is trained by using multiple sets of pieces of training data, wherein the sets comprise various kinds of plating process conditions and ground truth labels corresponding thereto. By adopting the above construction, the learning model 490, which is able to determine an expected process score accurately, is formed.

In step 802, various kinds of plating process conditions are inputted to the input nodes 491 in the learning model 490 that has been trained as explained above, and, in response to above inputting, an expected process score corresponding to the inputted plating process conditions is outputted from an output node 495 in the trained learning model 490. In the case that an expected process score obtained from the learning model 490 is not satisfactory, a plating process condition(s) to be inputted to the learning model 490 may be changed and step 802 may be performed repeatedly, until a satisfactory expected process score is obtained.

FIG. 8 is referred to again; and, next, in step 804, the processor 420 selects, from the multiple plating modules 200 in the plating apparatus 100 and based on the expected process score obtained in step 802, a plating module which will be used for the plating process for the substrate. For example, in above step 802, by using various kinds of pieces of the substrate information and the module information as plating process conditions that are to be inputted to the learning model 490, expected process scores relating to respective substrate types of substrates, to which plating processes are to be applied, and respective plating modules 200 in the plating apparatus 100 are obtained. In step 804, for example, the processor 420 may select, for each substrate type, a plating module having a maximum expected process score as a plating module which is to be used for applying a plating process to a substrate of the above substrate type. It can be expected by using the above selected plating module that a plating film having the best quality (for example, good in-plane uniformity of film thickness) is obtained.

Next, in step 806, the processor 420 controls the plating apparatus 100 to perform the plating process for the substrate by using the plating module selected in step 804. Thus, the plating process for the substrate is performed by using a plating module 200 by which a high-quality plating film is expected to be formed.

As explained above, according to the present embodiment, by selecting a plating module 200 based on expected quality (an expected process score) of a plating film that is expected to be obtained by performing a plating process, the plating process for a substrate can be performed by using the appropriate plating module 200. Accordingly, a high-quality plating film can be formed on a substrate in the plating apparatus 100.

On the other hand, regarding the above-explained first to third embodiments, there may be cases that the degrees of quality and the expected process scores relating to respective plating modules change over time; accordingly, instead of constructing the leaning models 480 and 490 by using the neural networks 487 and 497 which have simple inputs and outputs such as those shown in FIGS. 5 and 9, the leaning models may adopt recursive neural networks which are constructed in such a manner that the degrees of quality and the expected process scores outputted from the output layers 486 and 496 are again inputted to the input layers 482 and 492. Since states at previous points in time are also reflected by using a recursive neural network such as that explained above, it becomes possible to infer a degree of quality and an expected process score of a plating module more accurately.

In the above description, embodiments of the present invention have been explained based on some examples; and, in this regard, the above explained embodiments of the present invention are those used for facilitating understanding of the present invention, and are not those used for limiting the present invention. It is obvious that the present invention can be changed or modified without departing from the scope of the gist thereof, and that the present invention includes equivalents thereof. Further, it is possible to arbitrarily combine components or omit a component(s) disclosed in the claims and the specification, within the scope that at least part of the above-stated problems can be solved or within the scope that at least part of advantageous effect can be obtained.

### REFERENCE SIGNS LIST

10 System
100 Plating apparatus
200 Plating module
300 Film-thickness measuring unit
400 Controller
420 Processor
440 Memory
460 Program
480 Learning model
481 Input node
482 Input layer
483 Node
484 Middle layer
485 Output node
486 Output layer
487 Neural network
490 Learning model
491 Input node
492 Input layer
493 Node
494 Middle layer
495 Output node
496 Output layer
497 Neural network
500 Network

What is claimed is:

1. A method for controlling a plating apparatus, which comprises multiple plating modules, comprising steps for:
obtaining plating-film-thickness measurement data of multiple substrates, wherein the multiple substrates are those with respect to which plating processes applied thereto by the multiple plating modules have been completed;
determining a degree of quality of each plating module in the multiple plating modules, based on the plating-film-thickness measurement data; and
controlling a plating process in the plating apparatus, based on the degree of quality of each plating module.

2. The method as recited in claim 1, wherein the step for determining the degree of quality comprises a step for determining the degree of quality of each plating module, by using a learning model which has been trained by machine learning to output the degree of quality of the plating module after inputting of a target value relating to plating-film thickness and the plating-film-thickness measurement data of the substrate with respect to which the applied plating process has been completed.

3. The method as recited in claim 2, wherein the learning model is constructed to further receive at least one of (i) substrate information relating to a characteristic of the substrate, (ii) module information relating to a plating process performed in the plating module, and (iii) analysis result relating to components of a plating liquid used in the plating module, as an input parameter or input parameters.

4. The method as recited in claim 1, wherein the step for determining the degree of quality comprises a step for calculating a statistical value based on the plating-film-thickness measurement data and determining the degree of quality of each plating module based on the statistical value.

5. The method as recited in claim 1, wherein the step for controlling comprises control for selecting, from the multiple plating modules, a plating module which is to be used for performing the plating process.

6. The method as recited in claim 5, wherein the step for controlling comprises steps for:
constructing, based on the degrees of quality obtained in the step of determining, a database for storing degrees of quality relating to the respective substrate types and the respective plating modules;
designating a substrate type;
selecting, based on the designated substrate type and from the database, a plating module suitable for the substrate type; and
performing control to perform, by using the selected plating module, a plating process for a substrate of the designated substrate type.

7. The method as recited in claim 6, wherein control is performed in such a manner that plating modules having high degrees of quality only are used.

8. The method as recited in claim 6, wherein control is performed in such a manner that plating modules having high degrees of quality only are used for first-substrate-type substrates, and plating modules having low degrees of quality only are used for second-substrate-type substrates.

9. The method as recited in claim 1, wherein the step for controlling comprises steps for:
displaying a setting screen for designating an execution condition of a plating process, wherein the execution condition comprises designation that designates a degree of quality of a plating module which is to be used in the plating process; and
executing the plating process in accordance with the designated execution condition.

10. The method as recited in claim 9, wherein the execution condition includes at least one of (i) designation that designates the degree of priority with respect to timing to start processing of a substrate which is an object of processing, (ii) designation that designates the speed for conveying a substrate, (iii) designation that designates the degree of priority of salvaging of a substrate at the time when an error has occurred, and (iv) designation that designates an operation condition at the time when the process restarts after occurrence of an error.

11. A method for controlling a plating apparatus, which comprises multiple plating modules, comprising steps for:
determining, based on a predetermined plating process condition, an expected score relating to quality of thickness of a plating film which is to be formed when a plating process is performed in accordance with the plating process condition, wherein the determining is performed by using a learning model which is trained by machine learning to make it output the expected score when the predetermined plating process condition is inputted; and
controlling, based on the expected score obtained as a result of the determining, selection of a plating module which is to be used to perform the plating process.

12. A plating apparatus comprising multiple plating modules and a controller, wherein the controller is constructed to:
obtain plating-film-thickness measurement data of multiple substrates, wherein the multiple substrates are those with respect to which plating processes applied thereto by the multiple plating modules have been completed;
determine a degree of quality of each plating module in the multiple plating modules, based on the plating-film-thickness measurement data; and
control a plating process in the plating apparatus, based on the degree of quality of each plating module.

13. The plating apparatus as recited in claim 12, wherein
the controller comprises a learning model which has been trained by machine learning to output the degree of quality of the plating module after inputting of a target value relating to plating-film thickness and the plating-film-thickness measurement data of the substrate with respect to which the applied plating process has been completed; and
the controller determines the degree of quality of each plating module by using the learning model.

14. A plating apparatus comprising multiple plating modules and a controller, wherein the controller is constructed to:
determine, based on a predetermined plating process condition, an expected score relating to quality of thickness of a plating film which is to be formed when a plating process is performed in accordance with the plating process condition, and
control, based on the expected score obtained as a result of above determination, selection of a plating module which is to be used to perform the plating process;
wherein the controller comprise a learning model which is trained by machine learning to make it output the expected score when the predetermined plating process condition is inputted, and
the controller determines, by using the learning model and based on the predetermined plating process condition, the expected score.
